(19) United States
(12) Patent Application Publication
(10) Pub. No.: US 2018/0295904 A1
(43) Pub. Date: Oct. 18, 2018

(54) Chest Waders with Lighting Feature

(71) Applicant: Lee Looper, Jacksonville, AR (US)

(72) Inventor: Lee Looper, Jacksonville, AR (US)

(21) Appl. No.: 15/678,847

(22) Filed: Aug. 16, 2017

Related U.S. Application Data
(60) Provisional application No. 62/485,261, filed on Apr. 13, 2017.

(51) Int. Cl. A41D 13/02; A41D 1/08; A41D 1/00; A41D 27/20; A43B 3/00; A43B 3/02; A41F 9/00; F21V 33/00

(52) U.S. Cl. CPC A41D 13/02; A41D 1/08; A41D 1/002; A41D 27/205; A43B 3/001; F21V 23/02; A41F 9/002; F21V 33/0008; A41D 2600/106; A41D 2600/108; A43B 3/02

(57) ABSTRACT

A pair of water-resistant or waterproof chest waders includes at least one light source mounted to at least one area on the chest waders. The light source has multiple lighting elements facing toward different angles, thereby providing light in a number of directions simultaneously.

### CROSS-REFERENCE TO RELATED APPLICATIONS

This application claims the benefit of U.S. Provisional Patent Application No. 62/485,261, entitled “Chest Waders with Lighting Feature” and filed on Apr. 13, 2017. The complete disclosure of said provisional application is hereby incorporated by reference.

### STATEMENT REGARDING FEDERALLY SPONSORED RESEARCH OR DEVELOPMENT

Not applicable.

### BACKGROUND OF THE INVENTION

Chest waders are commonly used by sportsmen such as fly fishermen and hunters, particularly waterfowl hunters, while in the field. The purpose of chest waders for the waterfowl hunter is to allow the hunter to remain dry and warm while entering the water up to a certain depth in order to place and retrieve decoys, move to and from desired hunting locations, retrieve downed waterfowl, and the like. Because waterfowl hunters often begin the placement of decoys and other pre-hunt activities prior to sunrise, these activities must be performed in darkness. For that reason, a flashlight or other light source is required. But since the waterfowl hunter often has his hands full with decoys and other hunting accessories at the time, or is using his hands for various activities such as the placement of decoys, attachment or adjustment of decoy anchors, or the like, holding a flashlight during these activities is inconvenient and impractical. Thus an improved method of providing illumination for a waterfowl hunter while wearing chest waders is highly desired.

### BRIEF SUMMARY OF THE INVENTION

The present invention is directed to water protective clothing and more particularly to waders for use in a variety of sports including fishing. The present invention is designed to provide the user with a protectable, waterproof layer of clothing while also providing the user with sufficient lighting to engage in various activities. These and other features, objects and advantages of the present invention will become better understood from a consideration of the following detailed description of the preferred embodiments and appended claims in conjunction with the drawings as described following:

### BRIEF DESCRIPTION OF THE DRAWINGS

FIG. 1 is a perspective view of chest waders with a series of lights shown mounted in a vertical row on either or both of the left and right shoulder strap at the front of the chest wader. In this implementation, some of the lights in the vertical row are directed in a forward direction, while other lights are directed in a more sideward direction.

FIG. 2 is a perspective view of chest waders with a series of lights in a horizontal row shown mounted at the seam area above a front pocket on the chest waders. In this implementation, the lights are directed in a generally downward direction forming a fan-shaped light pattern.

FIG. 3 is a perspective view of chest waders with a series of lights in a horizontal row mounted on the front pocket flap on the chest waders. In this implementation, the lights are directed in a generally downward direction forming a fan-shaped light pattern.

FIG. 4 is a perspective view of chest waders with a series of lights mounted in a horizontal row on the front pocket on the chest waders. In this implementation, the lights are directed in a generally downward direction forming a fan-shaped light pattern.

FIG. 5 is a perspective view of chest waders with a series of lights mounted in a horizontal row on the chest area of the chest waders. In this implementation, the lights are directed in a generally downward direction forming a fan-shaped light pattern.

FIG. 6 is a perspective view of chest waders with a series of lights mounted in a horizontal row on the abdomen area of the chest waders. In this implementation, the lights are directed in a generally downward direction forming a fan-shaped light pattern.

FIG. 7 is a perspective view of chest waders with a series of lights mounted in two horizontal rows on the belt area of the chest waders, positioned to either side of a belt buckle. In this implementation, the lights are directed outwardly in an arc forming two fan-shaped light patterns.

FIG. 8 is a perspective view of chest waders with a series of lights mounted in two horizontal rows on the left upper boot and right upper boot section of the chest waders. In this implementation, the lights are directed outwardly in an arc forming two fan-shaped light patterns.

FIG. 9 is a perspective view of chest waders with a series of lights mounted in two horizontal rows on the left middle boot and right middle boot section of the chest waders. In this implementation, the lights are directed outwardly in an arc forming two fan-shaped light patterns.

FIG. 10 is a perspective view of chest waders with a series of lights mounted in two horizontal rows on the left toe and right toe section of the chest waders. In this implementation, the lights are directed outwardly in an arc forming two fan-shaped light patterns.

FIG. 11 is a perspective view of chest waders with a series of lights mounted in four vertical rows on the left and right sides of the left upper boot area and the left and right sides of the right upper boot area of the chest waders. In this implementation, the lights in each vertical row are directed in different directions from other lights in that row to create a fan pattern that covers a wide arc to the front and sides of the chest waders.

### DETAILED DESCRIPTION OF THE INVENTION

The present invention is directed to chest waders 2 that incorporate a light source 16 or multiple light sources at one or more of various locations. In particular implementations, the light source 16 or sources may be mounted at a shoulder strap 10, a front seam area 12 above a front pocket 14 such as commonly featured on many chest waders, a front pocket flap 26, on the front pocket 14 itself, on the chest area 12 when a front pocket 14 is not incorporated into the chest waders, on the abdomen area 6, on the belt area 18, on the front upper boot area 22, on the front middle boot area 28, on the boot toe area 24, on the side upper boot area 22, or any combination thereof. By providing lighting at or near the chest of the user, lighting is directed in the most desired direction for operations performed by the hunter. Light directed from the abdomen or lower areas of the chest waders may be more desirable for illuminating the area in front of the hunter while moving.

Turning to the figures, the general features of the waders of the present invention may be described. Generally, the waders 2 comprise various sections: an upper body section 4, lower body section 8, and a middle section 6 that joins the upper body section 4 and lower body section 8. In one embodiment, the sections 4, 6, 8 may all be manufactured as a single, integral piece, thereby eliminating any seams to enhance the waterproof characteristic of the waders 2. Alternatively, the sections 4, 6, 8 may be manufactured separately but joined together through sewing, zippers, or other connecting means that allow the user to wear the waders 2 as a single unit. In the preferred embodiment, the waders 2 are made of a durable, water-resistant or water proof material. For example, the waders 2 may be made of rubber, nylon, neoprene, canvas, or some other durable material. Furthermore, a camouflage pattern may be used to assist the hunter in concealing into the environment.

Each of the sections 4, 6, 8 listed above may be further described with regard to smaller zones or areas within that section that correspond to the portion of the user's body those sections are near when worn by the user. For example, the upper body section 4 has a chest area 12 and a front pocket 14 positioned on the center of the chest area 12, which can be used for holding accessories, tools, or other equipment. In addition, straps 10 may be connected on opposite sides of the upper body section 4 such that the user can place a strap 10 over each shoulder, thereby holding the chest waders 2 in place. Likewise, the middle section 6 may be described with regard to an abdomen area and a wader belt 18 may be located near the abdomen area 6. The wader belt 18 is configured to be placed around the waist of the wader user, further assisting in keeping the waders 2 in the appropriate position on the user's body during use. Finally, the lower body section 8 may be described with regard to a leg area 20 and a foot area. The foot area may be referred to as a “boot area” and can further be broken down into an upper boot area 22, middle boot area 28, and boot toe area 24. In one embodiment, the feet coverings are stocking-like coverings that can be used with a separate wading boot, allowing the user to modify the footwear (boot) depending on the situation or conditions. Alternatively, the feet coverings may comprise an integrated boot, which conveniently allow the user to slip on the waders and go, without requiring the purchase of a separate boot.

In addition to the various sections of the waders 2, the present invention also comprises a light source 16 or multiple light sources 16 mounted to the various sections of the waders 2. The light source 16 may be of various known types, including, for example, light emitting diode (LED) lights and incandescent lights, although LEDs are preferred due to the greater operational life of the light source and relatively low power required relative to the lumens of light emitted. There may be a single light source 16 or multiple light sources 16, arranged in any desired pattern, including a straight horizontal line or vertical line of light sources. By using multiple light sources 16, the light sources 16 may be individually directed in different directions in order to provide a desired illumination pattern. For example, in some implementations the lights 16 may be mounted so that some individual light devices are directed in front of the hunter, while others are directly more sidewardly, thereby providing a broader area of illumination for the hunter. In other implementations, the light sources 16 may be directed in a fan-shaped pattern in order to provide a broad arc of illumination for the hunter. Finally, the light source(s) 16 may be integral to the waders 2 or, alternatively, may be a separate piece that is mounted to the waders 2 using adhesive or other means.

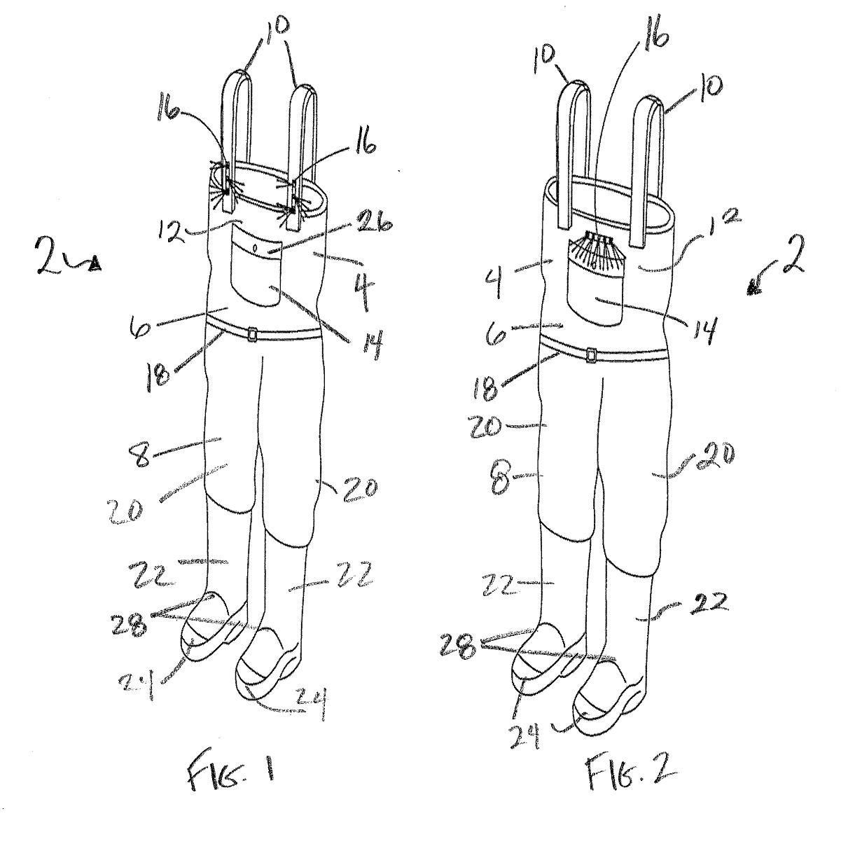

Referring now to the various drawings, the different embodiments of the present invention may be described. FIG. 1 shows one embodiment of the chest waders 2 having multiple light sources 16 mounted on the shoulder straps 10 of the waders 2. One light source 16 is mounted on the left shoulder strap 10 and another light source 16 is mounted on the right shoulder strap 10. While the drawings show the light sources 16 mounted on the lower front of the shoulder strap 10 (near where the shoulder strap 10 meets the upper body section 4 of the waders 2), it is understood that the light sources 16 may be placed in any configuration on the shoulder straps 10, depending on desired use. Furthermore, it is understood that only one shoulder strap 10 may have a light source 16 or both straps 10 may have a light source 16. In addition, the light sources 16 may be configured in a vertical row, as shown in the figures, or can be placed in a different arrangement. Also, as mentioned above, in order to modify the waders 2 for use in different situations, the direction of light emitted from the light sources 16 may be varied. For example, each of the light sources 16 may have multiple lighting devices (for example, multiple LED bulbs per light source), with each lighting device shining light in a different direction, as indicated by the arrows in FIG. 1—with some of the lights directed in a forward direction and some of the lights directed in a generally sideward direction. As discussed above, this may facilitate a broader rea of illumination for the hunter.

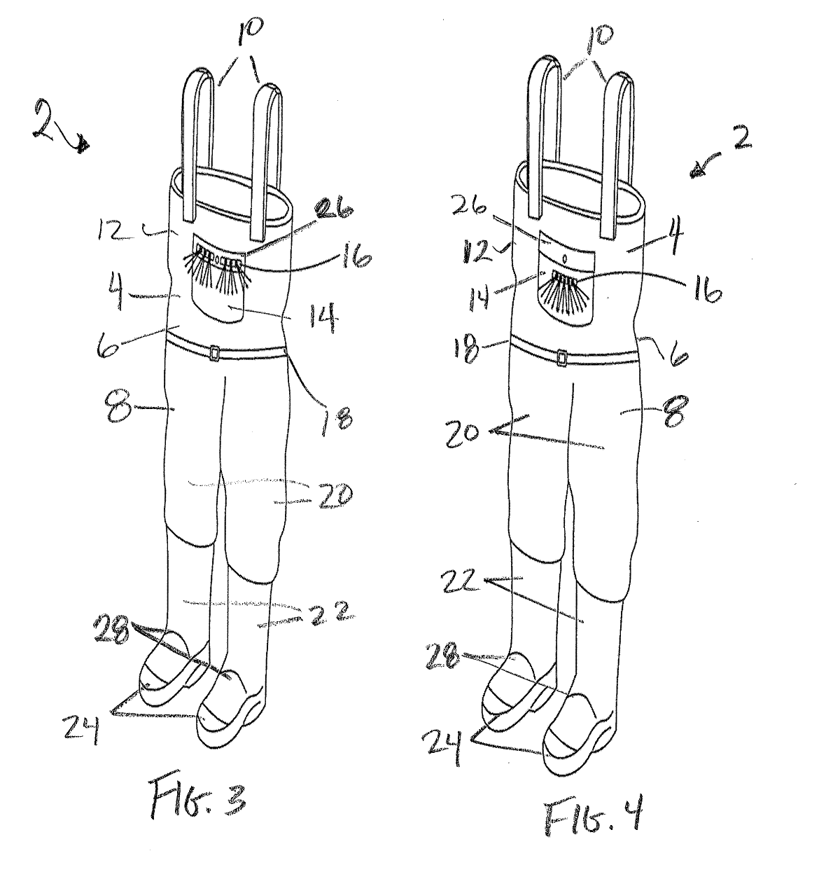

Turning now to FIGS. 2-5, various embodiments of the present invention with the light source(s) 16 mounted to the upper body section 4 of the waders 2 may be described. While it is contemplated that the light source(s) 16 can be configured in any position on the upper body section 4 of the waders 2, these particular embodiments are particularly preferable.

FIG. 2, for example, shows waders 2 having an upper body section 4 with a pocket 14 and the pocket 14 having an upper flap 26. A single light source 16 (which may comprise multiple lighting devices) is positioned on the front of the chest area 12 of the upper body section 4 above the pocket 14. In one embodiment, the light source 16 comprises a horizontal row of separate lighting devices, with each of the lighting devices directed in a generally downward direction forming a fan-shaped light pattern. This fan-shaped pattern facilitates an illumination of a wider area, which ultimately increases the user's visibility in the low light situation.

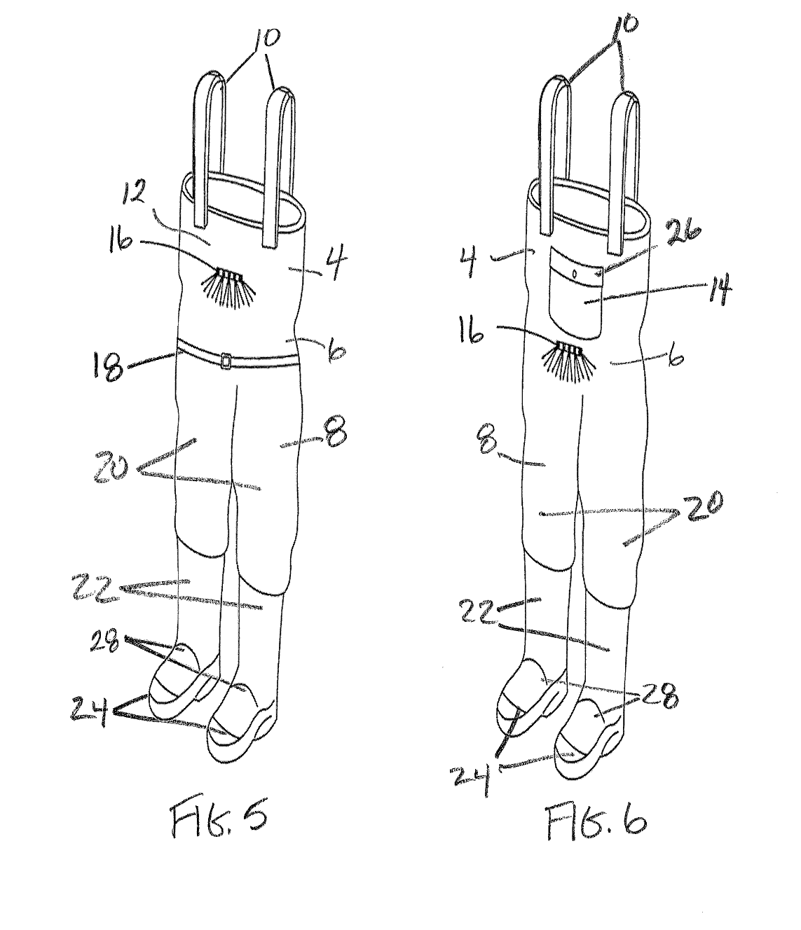

Alternatively, as shown in FIGS. 3-4, the light source 16 may be positioned directly on the pocket 14 that is on the front chest area 12 of the upper body section 4 of the chest waders 2. It is understood that the light source 16 may be positioned on the top of the pocket 14 (near to or on the opening flap 26) as shown in FIG. 3 or may be positioned near the middle or bottom of the pocket 14, as shown in FIG. 4. Again, a single light source 16 or multiple light sources 16 may be used. Finally, as shown in FIG. 5, in one embodiment, the upper body section 4 of the waders 2 may not have a pocket 14 and in such design, the light source 16 may be positioned on the center of the chest area 12 of the upper body section 4. While the drawings show the light sources 16 as horizontal rows of individual lighting devices directed in a generally downward fan-shaped direction, it is understood that any configuration is possible. In one embodiment, the chest area 12 may comprise an additional compartment (in addition to the pocket 14) for holding a battery pack that powers the lighting source 16. The compartment, for example, may be positioned underneath the pocket and may be accessible from a side opening in the chest area.

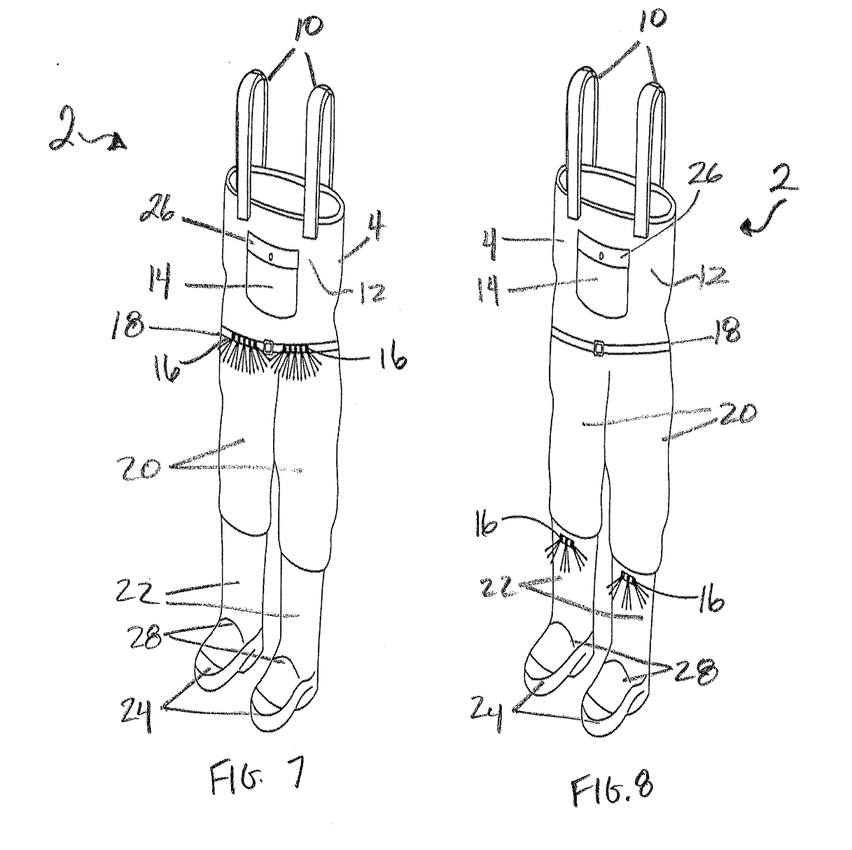

FIGS. 6-7 show various embodiments of the present invention having the light source 16 placed in a position on the middle section 6 of the waders 2. For example, the lighting source(s) 16 may be positioned below the chest area 12 of the upper body section 4 (or below the pocket 14 on the chest area 12 of the upper body section 4) so that it is configured to be positioned on the abdomen area 6 of the user when the waders 2 are being worn, as shown in FIG. 6. Alternatively, the light source 16 may be mounted to the wader belt 18, as shown in FIG. 7. The light source 16 may be integral to the wader belt 18, or may be a separate piece that is connected to the wader belt 18 via clips, adhesive, or other connecting means. In one embodiment, the belt 18 comprises two light sources 16, one on each side of the user's body. The light sources 16 may each comprise a horizontal row of individual lighting devices, which may be directed outwardly in an arc forming a fan-shaped pattern. With each light source 16 forming a fan-shaped pattern on opposite sides of the user's body, the area of coverage of illumination can be increased.

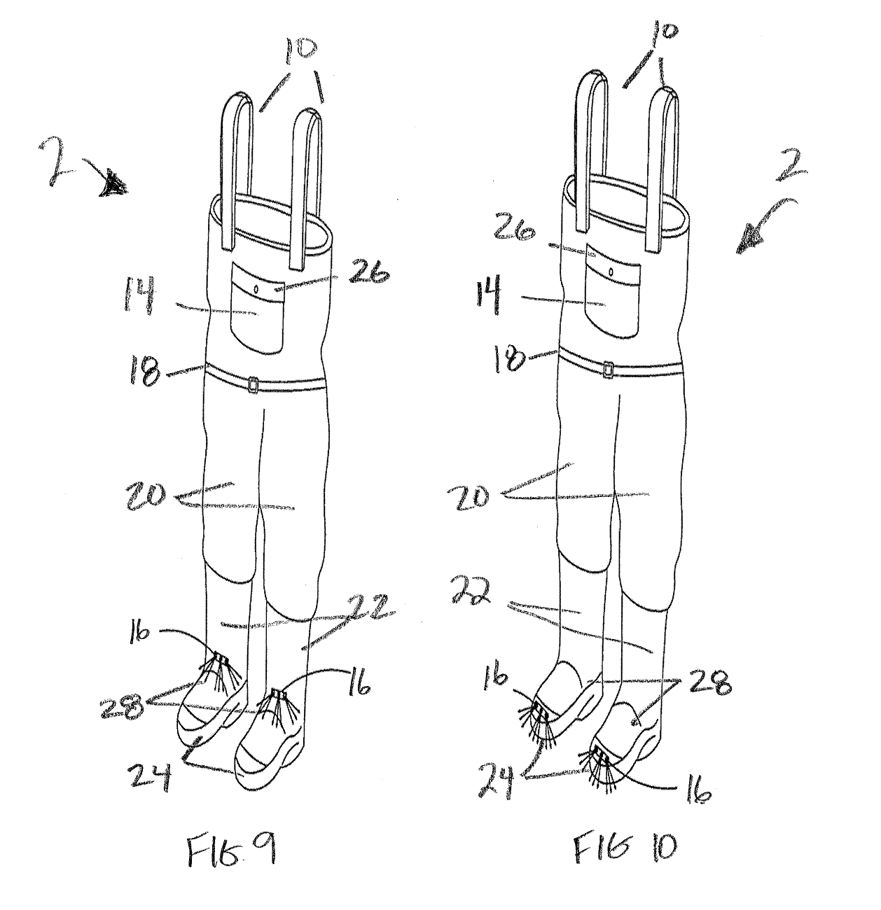

Finally, with regard to FIGS. 8-11, various embodiments of the present invention having the light source 16 mounted to the lower body section 8 of the waders 2 may be described. These particular embodiments may be particularly helpful given the lower positioning of the light sources 16 facilitates better illumination of the ground in front of the user. For situations in which the waders 2 are being worn in forests, woods, or other areas with potential debris in the path of the user, these embodiments can help the user navigate through the branches, leaves, bushes, or other debris on the ground. It is also contemplated that the light source(s) 16 positioned on the lower body section 8 of the waders 2 may facilitate illumination of the water in which the waders 2 are being used.

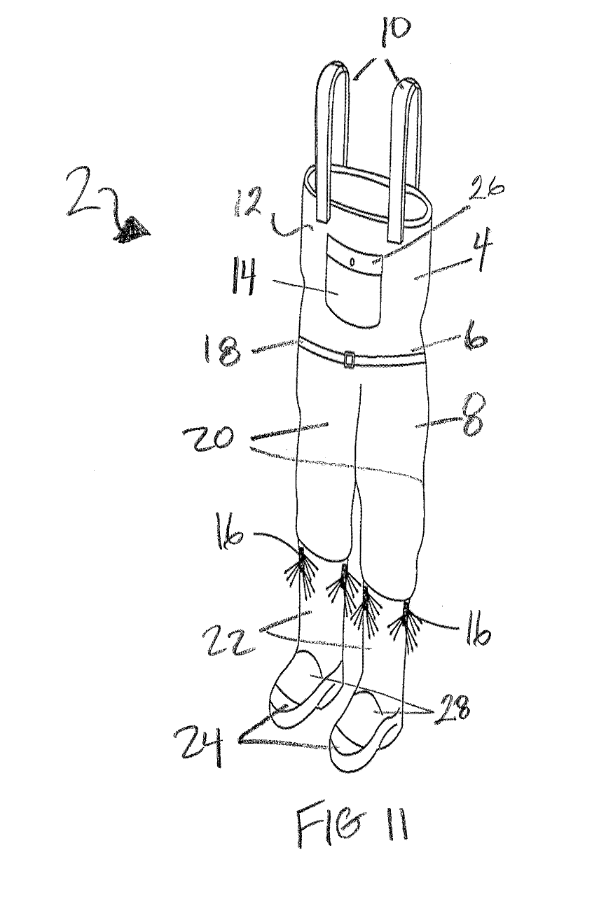

In one embodiment, as shown in FIG. 8, the light source 16 may be mounted to the top area 22 of the foot covering, near to the transition between the foot covering 22 and leg covering 20. It is contemplated that one light source 16 may be mounted to the left foot covering and one may be mounted to the right foot covering. Alternatively, as shown in FIG. 9, the light source(s) 16 may be positioned further down on the foot covering, near the middle area 28 of the foot covering. In yet another alternative embodiment, as shown in FIG. 10, the light source(s) 16 may be mounted even further down the foot covering on the boot toe area 24 near to where the toe of the user would be positioned. The light sources 16 may comprise horizontal rows of individual lighting devices, and the individual lighting devices may be positioned, for example, such that they are directed outwardly in an arc forming two-fan shaped light patterns. Alternatively, as shown in FIG. 11, the light source(s) 16 may be mounted on the top of the foot covering portion 22, with a light source 16 placed on the inside of the leg and the outside of the leg. The light source(s) 16 may comprise a vertical row of individual lighting devices and the individual lighting devices may be directed in different directions from other lights in the same row to create a fan pattern that covers a wide arc to the front and side of the waders.

While the above description has been given with respect to various embodiments having the light source(s) mounted at various positions on the waders, such descriptions are not intended to be limiting. Furthermore, it is understood that the various embodiments may be implemented independently or in combination. For example, it is contemplated that a light source can be placed on the upper body portion of the chest waders (as shown in FIGS. 1-5) while another light source (or multiple light sources) are positioned on the lower body portion of the waders (FIGS. 8-11). Any combination of light sources may be used according to the intended use of the waders.

Unless otherwise stated, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein. It will be apparent to those skilled in the art that many more modifications are possible without departing from the inventive concepts herein.

All terms used herein should be interpreted in the broadest possible manner consistent with the context. When a grouping is used herein, all individual members of the group and all combinations and subcombinations possible of the group are intended to be individually included in the disclosure. All references cited herein are hereby incorporated by reference to the extent that there is no inconsistency with the disclosure of this specification. If a range is expressed herein, such range is intended to encompass and disclose all sub-ranges within that range and all particular points within that range.

The present invention has been described with reference to certain embodiment(s) that are intended to be exemplary only and not limiting to the full scope of the present invention. Although a single placeholder claim is presented herein, the invention is not so limited, as it is intended that claims of larger scope will be presented in a subsequent non-provisional patent application.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. A pair of chest waders, comprising:
a. a first shoulder strap;
b. a second shoulder strap;
c. a first lower light positioned on the first shoulder strap and pointed in a first direction to provide illumination in the first direction; and
d. a first middle light positioned on the first shoulder strap vertically above the first lower light and pointed in a second direction different from the first direction to provide illumination in the second direction simultaneously with the illumination provided by the first lower light in the first direction thereby creating an area of illumination.

18. The pair of chest waders of claim 17, further comprising a first upper light positioned on the first shoulder strap vertically above the first lower light and first middle light and pointed in a third direction different from the first direction and second direction to provide illumination in the third direction simultaneously with the illumination provided by the first lower light in the first direction and the first middle light in the second direction thereby creating an area of illumination.

19. The pair of chest waders of claim 17, further comprising:
a. a second lower light positioned on the second shoulder strap and pointed in the first direction to provide illumination in the first direction along with the first lower light; and
b. a second middle light positioned on the second shoulder strap vertically above the second lower light and pointed in the second direction to provide illumination in the second direction along with the first middle light and simultaneously with the illumination provided by the first lower light and second lower light in the first direction thereby creating an area of illumination.

20. The pair of chest waders of claim 19, further comprising:
a. a first upper light positioned on the first shoulder strap vertically above the first lower light and first middle light and pointed in a third direction different from the first direction and second direction to provide illumination in the third direction; and
b. a second upper light positioned on the second shoulder strap vertically above the second lower light and second middle light and pointed in the third direction to provide illumination in the third direction simultaneously with the first upper light.

21. A pair of chest waders, comprising:
a. a middle section;
b. a left light attached to the middle section and pointed in a leftward direction in order to provide illumination in a leftward direction;
c. a right light attached to the middle section horizontally to the right of the left light and pointed in a rightward direction in order to provide illumination in a rightward direction simultaneously with the left light providing illumination in a leftward direction thereby creating an area of illumination.

22. The pair of chest waders of claim 21, further comprising a center light attached to the middle section horizontally to the right of the left light and to the left of the right light, and pointed in a forward direction in order to provide illumination in a forward direction simultaneously with the left light providing illumination in a leftward direction and the right light providing illumination in a rightward direction thereby creating an area of illumination.

23. The pair of chest waders of claim 22, wherein the chest waders further comprise a pocket attached at the middle section, and wherein the left light, right light, and middle light are positioned above the pocket.

24. The pair of chest waders of claim 22, wherein the chest waders further comprise a pocket and a pocket flap attached at the middle section, and wherein the left light, right light, and middle light are positioned on the pocket flap.

25. The pair of chest waders of claim 22, wherein the chest waders further comprise a pocket attached at the middle section, and wherein the left light, middle light, and right light are positioned on the pocket.

26. The pair of chest waders of claim 22, wherein the chest waders further comprise a pocket attached at the middle section, and wherein the left light, middle light, and right light are positioned below the pocket.

27. The pair of chest waders of claim 21, wherein the chest waders further comprise a belt attached at the middle section, and wherein the left light and right light are positioned on the belt.

28. The pair of chest waders of claim 27, further comprising a plurality of left lights and a plurality of right lights, wherein each of the left lights is pointed in a different direction from each of the other left lights and each of the right lights is pointed in a different direction from each of the other left lights thereby creating an area of illumination forwardly from the chest waders.

29. A pair of chest waders, comprising:
a. an integrated left boot;
b. an integrated right boot;
c. a left boot left light attached to the left boot and pointed in a leftward direction in order to provide illumination in a leftward direction;
d. a left boot right light attached to the left boot rightward of the left boot right light and pointed in a rightward direction in order to provide illumination in a rightward direction;
e. a right boot left light attached to the right boot and pointed in a leftward direction in order to provide illumination in a leftward direction; and
f. a right boot right light attached to the right boot rightward of the right boot right light and pointed in a rightward direction in order to provide illumination in a rightward direction.

30. The pair of chest waders of claim 29, further comprising:
a. a left boot middle light attached to the left boot horizontally between the left boot left light and left boot right light and pointed in a forward direction in order to provide illumination in a forward direction; and
b. a right boot middle light attached to the right boot horizontally between the right boot left light and right boot right light and pointed in a forward direction in order to provide illumination in a forward direction along with the left boot middle light.

31. The pair of chest waders of claim 30, wherein the left boot comprises an upper left boot and the right boot comprises an upper right boot, and further wherein the left boot left light, left boot middle light, and left boot right light are attached at the upper left boot, and wherein the right boot left light, right boot middle light, and right boot right light are attached at the upper right boot.

32. The pair of chest waders of claim 30, wherein the left boot comprises a middle left boot and the right boot comprises a middle right boot, and further wherein the left boot left light, left boot middle light, and left boot right light are attached at the middle left boot, and wherein the right boot left light, right boot middle light, and right boot right light are attached at the middle right boot.

33. The pair of chest waders of claim 30, wherein the left boot comprises a left toe and the right boot comprises a right toe, and further wherein the left boot left light, left boot middle light, and left boot right light are attached at the left boot toe, and wherein the right boot left light, right boot middle light, and right boot right light are attached at the right boot toe.

34. A pair of chest waders, comprising:
a. an integrated left boot comprising a left boot left side and a left boot right side;
b. an integrated right boot comprising a right boot left side and a right boot right side;
c. a left boot left row of lights aligned vertically at the left boot left side;
d. a left boot right row of lights aligned vertically at the left boot right side;
e. a right boot left row of lights aligned vertically at the right boot left side; and
f. a right boot right row of lights aligned vertically at the right boot right side,
wherein the left boot left row of lights, the left boot right row of lights, the right boot left row of lights, and the right bot right row of lights together provide a fan of illumination forwardly and sidewardly from the pair of chest waders.

35. The pair of chest waders of claim 34, wherein the left boot left row of lights comprises a first left boot left row light pointed forwardly to provide illumination in a forward direction and a second left boot left row light pointed sidewardly to provide illumination in a sideward direction, wherein the left boot right row of lights comprises a first left boot right row light pointed forwardly to provide illumination in a forward direction and a second left boot right row light pointed sidewardly to provide illumination in a sideward direction, wherein the right boot left row of lights comprises a first right boot left row light pointed forwardly to provide illumination in a forward direction and a second right boot left row light pointed sidewardly to provide illumination in a sideward direction, and wherein the right boot right row of lights comprises a first right boot right row light pointed forwardly to provide illumination in a forward direction and a second right boot right row light pointed sidewardly to provide illumination in a sideward direction.

36. The pair of chest waders of claim 35, wherein the left boot left row of lights further comprises a third left boot left row light pointed rearwardly to provide illumination in a rearward direction, wherein the left boot right row of lights further comprises a third left boot right row light pointed rearwardly to provide illumination in a rearward direction, wherein the right boot left row of lights further comprises a third right boot left row light pointed rearwardly to provide illumination in a rearward direction, and wherein the right boot right row of lights further comprises a third right boot right row light pointed rearwardly to provide illumination in a rearward direction.
